(19) United States
(12) Patent Application Publication
(10) Pub. No.: US 2014/0339188 A1
(43) Pub. Date: Nov. 20, 2014

(54) Telescopic Boom and Crane

(71) Applicant: Liebherr-Werk Ehingen GmbH, Ehingen/Donau (DE)

(72) Inventor: Sebastian BRZOSKA, Ehingen (DE)

(73) Assignee: Liebherr-Werk Ehingen GmbH, Ehingen/Donau (DE)

(21) Appl. No.: 14/250,030

(22) Filed: Apr. 10, 2014

(30) Foreign Application Priority Data
Apr. 11, 2013 (DE) 10 2013 006 259.4

(51) Int. Cl. B66C 23/70; B66C 23/18

(52) U.S. Cl. CPC B66C 23/708; B66C 23/185
USPC 212/348

(57) ABSTRACT

A telescopic boom for a crane has at least two telescopable telescoping sections in the form of lattice pieces, each of which exhibits a hollow structure that has in essence the shape of a box. The bottom chords of adjacent sections have in each instance a pinning structure to provide for pinning to each other during normal crane operations. By way of the design of at least the outer telescoping section, at least some of the force that is introduced into the pinned joint can be dissipated into the top chord of the boom.

### BACKGROUND OF THE INVENTION

This invention relates to a telescopic boom for a crane with at least two telescopable telescoping sections in the form of lattice pieces, each of which exhibits a hollow structure that has in essence the shape of a box.

A goal in the sector of wind power plants is to achieve very large hub heights for the wind wheels, in order to obtain a wind power on the rotor blades that is as homogenous as possible. Therefore, during the assembly of wind power plants the maximum achievable hub height represents a characteristic value for the required hoisting devices, usually mobile cranes having telescopic booms.

Because of the requirement to provide very large boom systems with large boom lengths, there is the problem that such dimensions make conventional telescopic booms too heavy. A significant reduction in weight can be obtained with lattice booms. However, telescopable booms have the advantage over conventional lattice booms that they can be quickly converted from a transport state into a working state and take up significantly less space during assembly. An additional advantage is that the total center of gravity of a crane with a long erected boom is very high, a feature that renders moving the crane to the construction site in the erected state extremely problematic or even impossible.

In order to combine the advantages of the above described types, suggestions for telescopable lattice booms have already been put forth. However, one difficulty with such telescopic booms is that of securing the extended adjacent telescoping sections in relation to each other for crane operations. Usually, securing is achieved by means of a plurality of pinned joints between the inner and outer telescoping section.

German document DE 20 2010 014 105 U1 discloses a pinning system for connecting the individual lattice elements of a telescopable lattice boom. In order to connect, all four corner struts of the lattice elements to be connected are pinned to each other. However, the drawback with the disclosed solution is that a high machining accuracy is necessary during the manufacture of the boom, in particular the pinning system, so that the resulting production costs are rapidly driven upwards.

### SUMMARY OF THE INVENTION

An object of the present invention is to provide an alternative solution for a telescopable lattice boom, which can be manufactured at a lower cost and yet has an adequate load carrying capacity.

This object is achieved by means of a telescopic boom exhibiting the claimed features. Advantageous embodiments of the telescopic boom are also claimed.

According to the invention, a telescopic boom for a crane with at least two telescopable telescoping sections is proposed. Each of the at least two telescopable telescoping sections has a hollow structure that has in essence the shape of a box, so that an inner telescoping section can be supported in the cavity that is formed in the outer telescoping section and can be moved relative to said outer telescoping section. The term “inner and outer telescoping section” refers to a pair of telescoping sections formed. Each inner telescoping section can accommodate an additional section and, in relation to this additional section, is considered to be the outer section. An outer telescoping section can be supported in the cavity of at least one additional section and, in relation to this additional section, is called the inner section.

The boom system preferably is composed of a plurality of telescoping sections that can be supported one inside the other and can be telescoped out in the usual manner.

The inventive idea is to connect together these large sections, which can be telescoped into each other, after they have taken their intended position in relation to each other for normal crane operations. In the normal crane operating position the bottom chord of the individual telescoping sections is subjected to a compression force, and the top chord of each telescoping section is subjected to a tensile force.

Adjacent telescoping sections are connected to each other in accordance with the invention by way of their top chords and secured in relation to each other. For this purpose at least one pinning means is arranged on the bottom chord, in order to form a pinned joint that connects the two telescoping sections. At least some of the telescoping sections can have at least one pin retainer for the connection with an adjacent inner and outer telescoping section.

Furthermore, means are arranged in accordance with the invention on at least one of the telescoping sections, in particular, on the outer telescoping section, as a result of which at least some of the force that is introduced into the pinned joint can be dissipated into the top chord of the boom. This arrangement allows a uniform distribution of the force, i.e. in both the bottom chord and in the top chord, to be achieved with, for example, only a single pinned joint in the region of the bottom chord between adjacent telescoping sections. At variance with the state of the art, a single pinned joint between adjacent telescoping sections is sufficient to achieve, nevertheless, an optimal force transfer. A reduced number of necessary pinned joints suffices to erect the crane. This arrangement reduces the accruing production costs and the erection costs.

The absorbed force of the pinned joint is the normal force that acts in the longitudinal direction of the inner telescoping section. Furthermore, the arrangement in the bottom chord induces an additional moment that has a positive effect on the fixed end region and the bearing region between the inner and the outer telescoping section. The normal force, which engages with the pinned joint, and/or the moment can be distributed as uniformly as possible over the components of the telescoping section by means of the pinned joint and the means according to the invention.

The individual telescoping sections are, in one arrangement, telescopable lattice pieces. Hence, the resulting boom system permits a substantial saving in weight, as compared to conventional telescopic booms. As an alternative, the individual telescoping sections can be suitable constructions of sheet metal plate.

Ideally one or more telescoping sections can comprise shell-shaped corner struts that are connected to each other by means of lattice bars, in order to achieve the customary lattice structure of the lattice pieces known from the prior art. In particular, the customary triangular structure is achieved by means of the arrangement of the individual lattice bars at the shell-shaped corner struts.

A stable, loadable and simultaneously comparatively light structure can be advantageously provided by the connection of the corner struts, each of which forms the outer edges of the box-shaped hollow structure, to the lattice bars. This arrangement allows high or rather large heights of lift to be easily implemented without simultaneously having to accept an unacceptable weight increase.

In principle, it is conceivable that in addition to the lattice bars connecting the corner struts, one or more connection plates are used, so that the box-shaped hollow structure has closed outer walls at least in sections and not only the lattice bars, arranged in a half-timbered manner, at the lateral faces of the hollow structure.

Furthermore, it can be provided that the corner struts are configured so as to be edged and/or bent and/or are manufactured from tubular sections and/or from extruded profiles. With the use of semi-finished products it is advantageously possible to lower the cost of production and to ensure simultaneously the quality of the components that are used.

Ideally the means comprise one or more lattice bars that are connected to the pinned joint and that dissipate at least some of the force that is introduced into the pinned joint into the top chord. In particular, the specific dimensioning of the lattice bars that are used makes it possible to remove a relevant portion of the normal force from the bottom corner struts and to introduce said relevant portion of the normal force into the upper corner struts.

In a particularly advantageous embodiment at least one pinning means is designed as a pin retainer in the form of a sheet metal pinning plate with a passage opening. The pinning plate connects the two corner struts of the bottom chord of a telescoping section. One passage opening that is provided inside the pinning plate is used to receive or more specifically to feed through the connecting pin. It is particularly advantageous if the feed-through is arranged centrally between the corner struts.

In order not to introduce the normal force, which engages with the pinned joint, directly into the corner struts of the bottom chord of the telescoping section, the retainer of the pinned joint is designed to achieve a specific objective. For example, it is useful to design the pinning plate in such a way that it is elastic. In particular, the width of the pinning plate may taper off in the direction of the corner struts, a feature that results in an elastic behavior of the pinning plate.

In addition, the pinned joint or more specifically the pinning plate that is used may be connected to one or more corner struts of the bottom chord by means of one or more tension rods. Hence, the force acting on the pinned joint is introduced into the corner struts of the bottom chord by means of the pinning plate and the connected tension rods.

Furthermore, it is conceivable that the connecting point(s) of one or more of the aforementioned tension rods with the at least one corner strut of the bottom chord is and/or are connected by means of one or more compression struts to the top chord, in particular the one or more corner struts of the top chord. The applied tensile stress inside the tension rods of the bottom chord can be dissipated into the top chord by means of the compression struts.

In order to achieve the maximum extension length possible, the pinning means of the at least one inner telescoping section can be arranged at the end, i.e. on its end facing away from the boom. The pinning means of the inner telescoping section is preferably a pinning unit with a movable pin.

Each telescoping section has two ends: the collar on its outer end and the end piece on its inner end, i.e. the end facing the boom axis. Ideally the telescoping sections have on their outer end, which forms the surrounding telescoping section, a pin retainer in the form of a pinning plate with a passage hole, and provide on their end piece, which forms the inner telescoping section, a pinning unit, which is mounted preferably rigidly on the end piece and has a movable pin. This pin can be driven by an additional unit and can be inserted into the pin retainer of the outer telescoping section, i.e. into the passage hole of the pinning plate. The pin can be held preferably automatically in the connection position.

The pin that is used is inserted advantageously perpendicular to the defined surface area of the bottom chords. The pin is inserted accordingly perpendicular through the pinning unit and the pinning plate of the inner and outer telescoping section.

The fixed end region can be designed in such a way that it is stiffened. The fixed end region is defined as the region between the bearing points that connect the two telescoping sections to each other. Preferably each bottom chord and each top chord has four bearing points, i.e. two per corner strut. The distance between two bearing points per corner strut defines the fixed end region.

The stiffening of the inner and/or outer telescoping section optimizes the force distribution in the fixed end region. For example, it is conceivable that the fixed end region is configured with one or more stiffeners.

The telescopic boom according to the invention can have a guy rope that guys the booms completely or at least partially. When a guying frame is used, the boom system is connected to the superstructure by means of a luffing rope. It is also conceivable that the guy rope runs only as far as up to the second uppermost telescoping section, because this arrangement decreases the resulting unsupported length, over which buckling occurs, and the buckling load.

In addition, the invention relates to an individual telescoping section for the telescopic boom according to the invention. The telescoping section here is a lattice piece with a box-shaped hollow structure, and the telescoping section has a pin retainer as well as means for dissipating the force into its top chord. The advantages and properties of the telescoping section according to the invention correspond to those of the inventive telescopic boom, for which reason there is no need to discuss again the details at this point.

In addition, the invention relates to a crane, in particular a mobile crane, with the telescopic boom according to the invention. The advantages and properties of the crane according to the invention correspond to those of the inventive telescopic boom. The crane lends itself, in particular, to erecting wind power plants. The inventive nature of the boom system permits a high boom length and an extremely steep angle position of the boom system, as a result of which particularly high heights of lift can be realized.

Additional advantages and details of the invention are explained in detail below with reference to the drawings.

### BRIEF DESCRIPTION OF THE DRAWINGS

FIGS. 1A and 1B are schematic representations of a crane for the purpose of explaining the internal forces and moments induced by the attacking forces.

FIG. 2 is a detailed illustration of the inventive telescopic boom with two telescoping sections that are supported one inside the other.

FIG. 3 is a perspective side view of the outer section of the telescopic boom shown in FIG. 2.

FIG. 4 is a perspective side view of the inner section of the telescopic boom shown in FIG. 2.

### DETAILED DESCRIPTION OF THE DRAWINGS

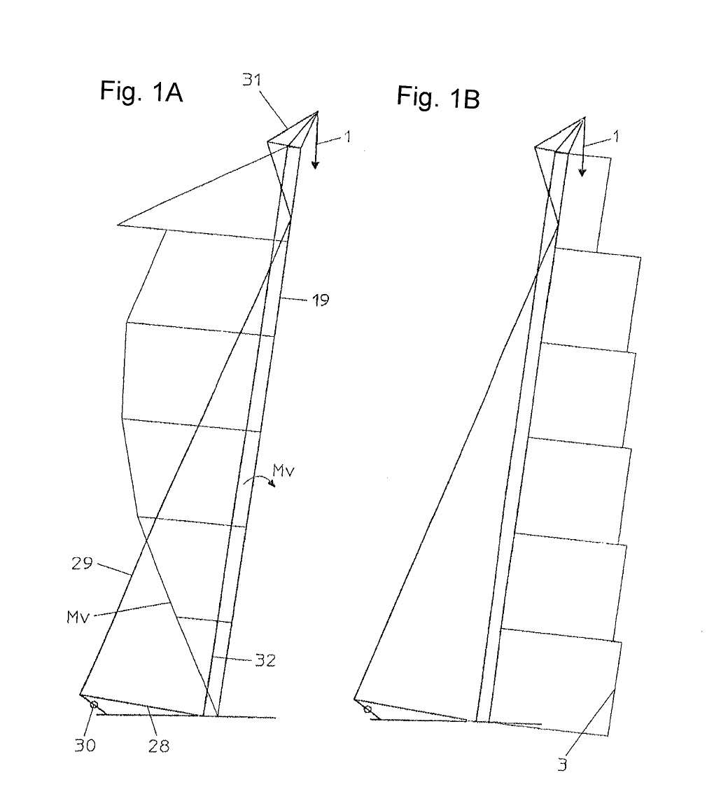

To begin with, the forces acting on a crane shall be briefly explained by means of the presentation of FIG. 1A. FIG. 1A shows a boom 19 and a moment Mv, which has been plotted along the boom 19 and which is induced by a load lift. The figure shows that the boom 19 is reduced to a bar, because from a static perspective it is customary to show the amount of a moment acting on a bar in a diagram, where the X axis is defined by the bar. For the sake of completeness the effective direction of the moment is indicated.

Therefore, the moment Mv shows the moment that acts on the bar at a certain distance from the luffing axis of the boom. This can be called the global moment, at which the design of the boom 19 is not considered. As a result, it may involve not only a telescopable boom, but also a boom that is assembled from individual elements. Even the method for luffing the boom 19 is irrelevant.

The telescopable boom 19 according to the invention involves a large telescopable lattice boom of individual lattice pieces that can be telescoped in or out in the customary way. The drawing according to FIG. 1A shows the boom 19 in the extended position. The guying system 29, the boom 19 and the guying frame 28 form a defined triangle. The guying system 29 is adapted to the respective boom length and, as a result, is length variable. The luffing angle is adjusted by pulling in or letting out the luffing rope 30, which runs from the guying frame 28 to the superstructure of the crane. In this way the aforementioned triangle is luffed as a whole. However, as an alternative, the luffing can also be performed by means of a luffing cylinder.

A typical wind power tip 31 is attached to the boom head. The hoisting rope is marked with the reference numeral 32. In order to optimize the design of the load on the boom, the guying system 29 is not run up to the boom tip, but rather ends at the tip of the second uppermost telescoping section. This arrangement reduces the load with respect to a potential buckling, because the entire unsupported length, over which buckling occurs, is shortened. Each defined extension length of the boom 19 is assigned a specific length of the guying system 29.

Furthermore, FIG. 1A shows the moment Mv, which is induced by the load 1, on the boom 19. Starting at the boom tip, this moment increases linearly at first, because the guying system 29 is fastened only at the end of the second uppermost telescoping section. Then after the engagement point of the guying system 29, the moment Mv decreases until it reaches the zero value at the pivot axis of the boom 19. The compression force occurs on the underside of the boom (bottom chord), i.e. the side of the boom that faces the load, whereas a tensile force is applied at the opposite top side (top chord) of the boom 19.

The attacking moment Mv leads to a deflection of the boom 19 and to a resulting lever arm of the normal force F_{N}. Both are transmitted from the respective inner telescoping section into the adjacent outer telescoping section. The place of the transmission is referred to as the so-called fixed end region that is defined by the distance between the bearing points of the inner telescoping section in the cavity of the outer telescoping section. The force ratios in the fixed end region are referred to as the locally occurring moments and depend on the concrete geometry of the structure of this fixed end region or more specifically on the connection of the adjacent telescoping sections.

Working on this basis, the resulting total load on the boom 19 is made up of the global moment Mv and the respective local moments in the individual fixed end regions of the specific number of sections of the telescopic boom.

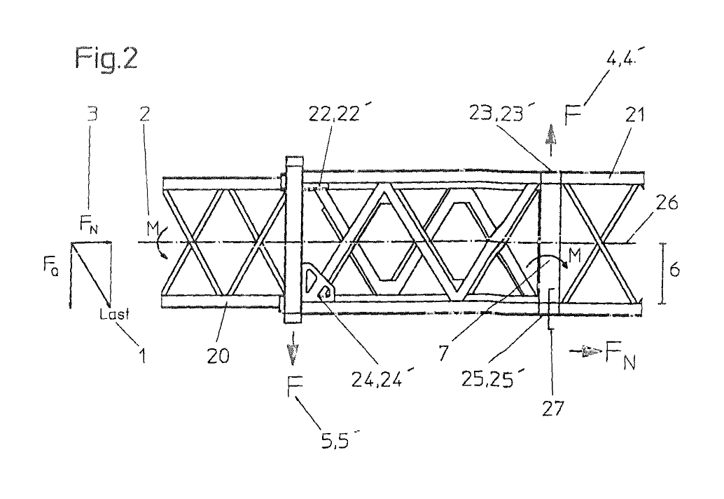

The purpose of FIG. 2 is to elucidate once again the force ratios in the fixed end region of two adjacent sections of the telescopic boom that are connected to each other in accordance with the technical teaching of the invention. The drawing shows a side view of an inner telescoping section 20, which is mounted in the box-shaped cavity of the outer telescoping section 21 by means of the bearing points 22, 22′, 23, 23′, 24, 24′, 25, 25′.

The load 1 produces in the inner telescoping section 20 a moment M and a normal force F_{N} in the longitudinal direction of the inner telescoping section 20. The inner telescoping section 20 passes both the moment and the normal force into the outer telescoping section 21, so that the normal force F_{N} is a compression force and acts in the longitudinal direction in the center axis 26 of the inner telescoping section 20. The moment M can be divided into a pair of forces, each of which is in a plane parallel to the luffing plane. The bearing points 22, 23, 24 and 25 enclose a first plane, whereas the bearing points 22′, 23′, 24′, and 25′ enclose a second plane. Hence, a force F 5 acts in the bearing point 24; and a force F 5′ acts in the bearing point 24′ respectively. The associated force F 4 acts in the bearing point 23; and the force F 4′ acts in the bearing point 23′. The forces depend more or less on the distance between the bearing points 23, 24.

In a first step the related forces F4, 4′ and F 5, 5′ respectively are assumed to have the same magnitude. At this point these forces are superimposed with the following effect that is induced by introducing the normal force F_{N} from the inner telescoping section 20 into the outer telescoping section 21. The normal force F_{N} acts in the center axis 26 and is transmitted by means of the pinned joint 27 to the two bottom chords of the telescoping sections 20, 21. Hence, this normal force F_{N} causes a counter-moment, which counteracts the applied moment M, over the distance 6 between the center axis 26 and the pinned joint 27. The counter-moment 7 can also be divided into a pair of forces that counteract the forces F 4, 4′, 5, 5′ respectively and, in so doing, minimize them.

FIG. 1B shows the normal force F_{N} that is to be absorbed in the respective pinned joints 27 between the individual telescoping sections of the boom 19. The normal force F_{N} is induced more or less by the load 1 over the outermost telescoping section, i.e. in the region of the boom tip. The force increases suddenly, when the holding force of the guying system 29 also enters into the calculation. In this case it is essential for the invention that the normal force F_{N} be a compression force. However, in theory the normal force could also be assumed to be the tensile force, provided that the moment were to act in the opposite direction to the moment Mv.

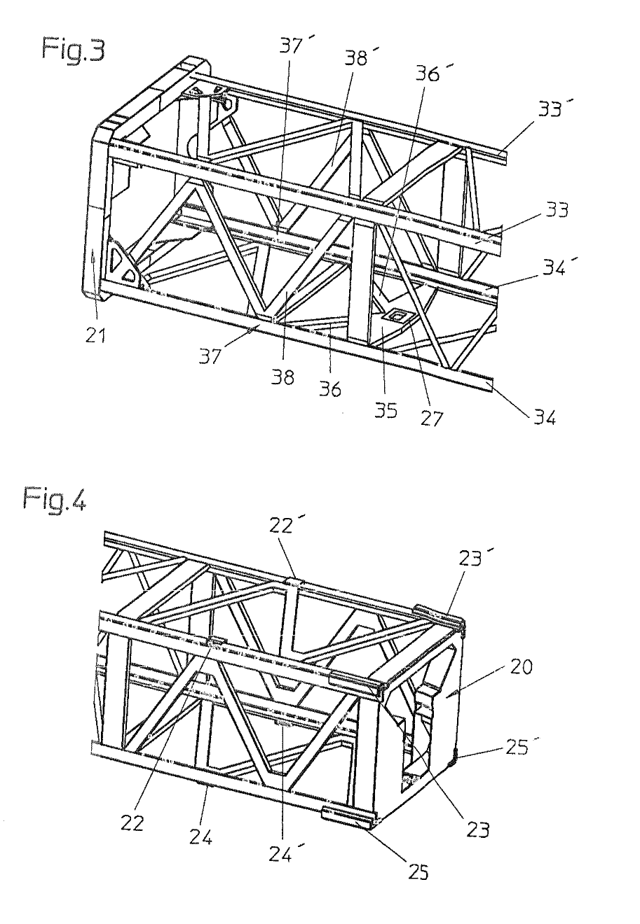

In order to optimize the load applied to the fixed end region of the pairs of telescoping sections 20, 21 and in order not to increase over-proportionally by means of the bottom chord pinning the pressure that is already being applied to the bottom chords in any event, in addition to the pinned joint 27, additional measures are taken; and these additional measures shall be described below with reference to FIGS. 3 and 4.

FIG. 3 shows the construction of the outer telescoping section 21 in a perspective side view. The telescoping section 21 corresponds in essence to a lattice element with a hollow structure in the shape of a box. The corners or rather the edges of the box shape are formed by the shell-shaped corner struts 33, 33′, 34, 34′. The individual corner struts are connected to each other by means of a plurality of lattice bars. In this case the individual lattice bars are arranged in a manner that allows the formation of a triangular structure that is advantageous in terms of the statics of the lattice elements.

In addition to the lattice bars connecting the corner struts, individual sheet metal connection plates 35 are provided, so that the box-shaped hollow structure has closed outer walls at least in sections and not only the lattice bars, arranged in a half-timbered manner, at the lateral faces of the hollow structure.

The bottom chord of the outer telescoping section that is shown is formed by the surface area defined by the bottom corner struts 34, 34′. The sheet metal plate 35, which connects the two corner struts 34, 34′ in the plane of the bottom chord, has a pin retainer 27 with a continuous bore hole. In order to connect, a single pin is inserted transversely to the surface of the sheet metal connection plate 35.

A key aspect of the invention for its successful implementation consists of the fact that the normal force F_{N} be transmitted as uniformly as possible to the corner struts 33, 33′, 34 and 34′. Without special measures the bottom corner struts 34, 34′ would be subjected to considerably more stress from the inner telescoping section or more specifically the outgoing normal force F_{N} than the upper corner struts 33, 33′. In order not to introduce the normal force F_{N} immediately into the corner struts 34, 34′, the retainer of the pinned joint 27 is designed to achieve the objective that the width of the sheet metal plate 35 tapers off in the direction of the corner struts 34, 34′. Owing to this arrangement the sheet metal plate acquires elastic properties. However, the tension rods 36, 36′, which meet at the sheet metal plate 35 in the region of the pin retainer 27 and connect said pin retainer to the corner struts 34, 34′, are put under tensile stress by means of the rationally designed deformation.

The tension rods 36, 36′ are connected to the corner struts 34, 34′ in the connecting nodes 37, 37′. In order to remove the force in the top chord, the connecting nodes 37, 37′ are connected by means of compression struts 38, 38′ to the top chord of the telescoping section, in particular to the two corner struts 33, 33′ of the top chord. By rationally designing the nodes 37, 37′ and by suitably dimensioning the compression struts 38, 38′, a relevant portion of the normal force F_{N} can be removed from the bottom corner struts 34, 34′ and can be introduced into the upper corner struts 33, 33′.

Furthermore, a stiffer fixed end region may facilitate the uniform introduction of the forces into all four corner struts. For this purpose the fixed end region could also be constructed in the form of a box with stiffeners.

FIG. 4 shows the configuration of the inner telescoping section 20. It is clear from the perspective side view that the telescoping section also comprises four sheet metal plates on its end region, i.e. that end facing away from the boom axis. In this case the pinning plate that extends in the plane of the bottom chord has a pinning unit with a movable pin. In order to pin the outer telescoping section, the pin can be inserted through the bore hole of the pin retainer 27.

So-called bearing points 22, 22′, 23, 23′, 24, 24′, 25, 25′ are arranged on the outer edge of the individual corner struts 33, 33′, 34, 34; in so doing, the inner telescoping section 20 is mounted in the cavity of the outer telescoping section 21 in such a way that the inner telescoping section can be displaced. Although the term “corner strut” is used, this element may also be, as an alternative, an angle bracket or a bent sheet metal plate. Additional types of designs are just as conceivable in order to transmit the normal force F_{N} from the bottom chord, or more specifically the pinned joint 27, into the top chord. It should always be provided by means of suitable measures that some of the force that is transmitted from the pin be transmitted into the top chord.

1-15. (canceled)

16. A telescopic boom for a crane comprising:
at least two telescopable telescoping sections formed as lattice pieces, each of which exhibits a box-shaped hollow structure, each of the sections having a bottom chord;
pinning structure provided to each of the bottom chords of adjacent sections, the pinning structure provided in order to pin the adjacent sections to each other during normal crane operations; and
dissipating structure arranged on an outer one of the at least two telescoping sections by way of which at least some force introduced into the pinning structure can be dissipated into a top chord of the boom.

17. The telescopic boom as claimed in claim 16, wherein at least one of the telescoping sections comprises shell-shaped corner struts that are connected to each other by lattice bars to form a triangular structure.

18. The telescopic boom as claimed in claim 16, wherein the pinning structure is formed by a pinned joint, and the dissipating structure comprises at least one lattice bar connected to the pinned joint that dissipates at least some of the force introduced to the pinned joint into a top chord of one of the telescoping sections.

19. The telescopic boom as claimed in claim 18, wherein the pinned joint is designed as a pin retainer in the form of a sheet metal pinning plate with a passage opening and connects two corner struts of the bottom chord of at least one of the adjacent sections.

20. The telescopic boom as claimed in claim 19, wherein the pinning plate has a width that is tapered off in a direction of the corner struts in such a way that it is elastic.

21. The telescopic boom as claimed in claim 20, wherein, in addition to the at least one lattice bar, sheet metal connection plates are used so that the box-shaped hollow structure includes outer walls that are closed at least in sections, and wherein one of the connection plates, which is arranged on the bottom chord, corresponds to the pinning plate.

22. The telescopic boom as claimed in claim 21, wherein the pinning plate is connected to at least one corner strut of the bottom chord by at least one tension rod.

23. The telescopic boom as claimed in claim 22, wherein at least one connecting point of the at least one tension rod to the at least one corner strut of the bottom chord is connected by at least one compression strut to the at least one corner strut of the top chord.

24. The telescopic boom as claimed in claim 16, wherein the pinning structure comprises a pinning unit arranged at the end of the inner telescoping section and having a movable pin.

25. The telescopic boom as claimed in claim 24, wherein the pin is guided perpendicular to a defined surface area of the bottom chords through the pinning unit and a pin retainer of the telescoping sections.

26. The telescopic boom as claimed in claim 16, wherein the boom has a fixed end region designed in such a way that it is stiffened by way of one or more stiffeners.

27. The telescopic boom as claimed in claim 17, wherein the corner struts are configured so as to be at least one of edged, bent, and manufactured from tubular sections, extruded profiles, or both tubular sections and extended profiles.

28. The telescopic boom as claimed in claim 16, wherein the boom is guyed by a guying system that connects the boom to a guying frame.

29. A telescoping section for a telescopic boom as claimed in claim 16.

30. A mobile crane for assembly of a wind power plant comprising a telescopic boom as claimed in claim 16.

31. A mobile crane for assembly of a wind power plant comprising a telescopic boom as claimed in claim 17.

32. A mobile crane for assembly of a wind power plant comprising a telescopic boom as claimed in claim 18.

33. A mobile crane for assembly of a wind power plant comprising a telescopic boom as claimed in claim 24.

34. A mobile crane for assembly of a wind power plant comprising a telescopic boom as claimed in claim 26.

35. A mobile crane for assembly of a wind power plant comprising a telescopic boom as claimed in claim 28.
